(19) United States
(12) Patent Application Publication
(10) Pub. No.: US 2015/0239784 A1
(43) Pub. Date: Aug. 27, 2015

(54) FAST-SETTING CEMENTS FOR WELL ABANDONMENT

(71) Applicant: Apache Corporation, Houston,, TX (US)

(72) Inventor: Michael Cowan, Sugar Land, TX (US)

(73) Assignee: APACHE CORPORATION, Houston, TX (US)

(21) Appl. No.: 14/430,177

(22) PCT Filed: Oct. 8, 2013
(86) PCT No.: PCT/US2013/063759

§ 371 Date: Mar. 20, 2015

Related U.S. Application Data
(60) Provisional application No. 61/713,655, filed on Oct. 15, 2012.

(51) Int. Cl. C04B 28/30; C09K 8/46; E21B 33/138

(52) U.S. Cl. CPC C04B 28/30; E21B 33/138; C09K 8/46

(57) ABSTRACT

A cement composition for sealing leaks in a wellbore includes at least one of an alkali and a transition metal oxide and an acid. A method for using the cement composition includes pumping the at least one of an alkali and a transition metal oxide and an acid as separate components into a wellbore so that a setting reaction begins after pumping is initiated.

### BACKGROUND

This disclosure relates generally to the field of compositions of cement used to seal the annular space between a drilled wellbore and the wall of a pipe of casing set therein. More specifically, the invention relates to compositions for such cement that set more quickly than convention cement and may be used to seal fluid, e.g., gas, leakage into the annular space of previously cemented pipe in a wellbore.

Cement of various compositions is used to seal an annular space between the wall of a drilled wellbore and a pipe or casing inserted into the wellbore. The cement serves, among other purposes, to hydraulically seal the annular space to prevent migration of fluids (oil, water and/or gas) between formations penetrated by the wellbore or migration of such fluids outside the annular space itself. During initial placement of cement, i.e., the “primary” cementing operation, pressure may be applied to the cement in the annular space and/or in the wellbore to enable proper sealing of the annular space during the time within which the cement, originally pumped as a liquid slurry, hardens and can form a hydraulic seal.

There are situations when the cement must be placed in a wellbore or annulus wherein: (1) the wellbore or annulus cannot be closed (sealed to form a pressure containment) after placement of the cement; (2) additional pressure cannot be applied to the sealed wellbore or annulus to force the cement into any leak path for fluids (i.e. cement cannot be ‘squeezed’ into place and held until it sets); (3) additional pressure cannot be applied to hold the cement in place until it sets; (4) additional pressure cannot be applied to increase pressure within the cement to prevent fluid from migrating through the cement before it sets (i.e., to prevent forming a permanent channel through the cement before or during the setting of the cement); and (5) additional pressure methods include pump pressure or increasing hydrostatic pressure within the closed annulus.

### SUMMARY

One aspect is a cement composition for sealing leaks in a wellbore includes at least one of an alkali and a transition metal oxide and an acid. A method for using the cement composition includes pumping the at least one of an alkali and a transition metal oxide and an acid as separate components into a wellbore so that a setting reaction begins after pumping is initiated.

Other aspects and advantages will be apparent from the description and claims which follow.

### BRIEF DESCRIPTION OF THE DRAWINGS

FIG. 1 shows a conductor pipe and a surface casing of a subsea wellbore in which gas leaks into the annular space between the wellbore wall and the surface casing.

FIG. 2 shows pumping cement into the annular space using a line from the surface.

FIG. 3 shows a plug of cement according to various example compositions used to seal the leaking gas in the annular space.

FIGS. 4A and 4B show graphs, respectively, of hydrostatic pressure exerted by curing conventional cement and cement strength with respect to time, referenced to gas pressure in a subsurface formation and critical cement strength to stop gas flow.

FIGS. 5A and 5B, show graphs similar to those in FIGS. 4A and 4B, respectively, but using an example cement composition according to the present disclosure.

FIG. 6 shows a surface equipment layout for using a two-component, fast-setting system using a high pressure, positive displacement pump common to cementing and well operations wherein the two components are mixed on the surface as they are pumped into the well.

FIG. 7 shows a surface equipment layout for using a two-component, fast setting cement system with small, low pressure chemical injection pumps.

FIGS. 8A and 8B show how separate lines, mixing locations and mixing equipment can be used to place two-component, fast-setting cements.

### DETAILED DESCRIPTION

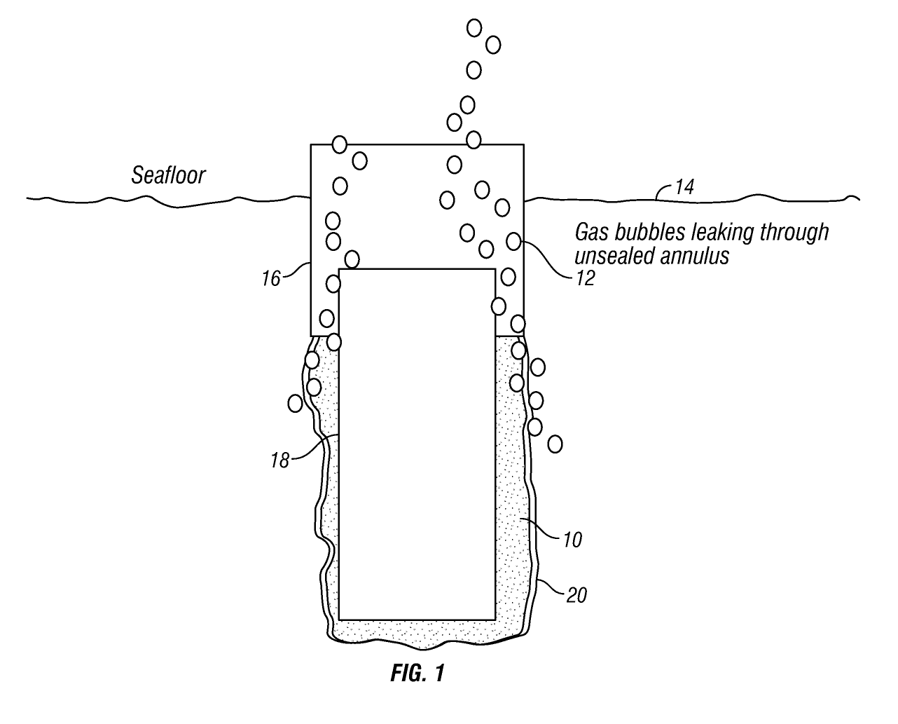

FIG. 1 shows an example subsea wellbore 20 in which a conductor pipe 16 has been previously driven (e.g., such as by a pile driver) through the water bottom or sea floor 14. During drilling and production from the wellbore 20, a surface casing 18 forms part of the wellbore 20. The surface casing 18 may be cemented in place in the wellbore 20 using cement 10 of compositions well known in the art. At the time the wellbore 20 is to be abandoned, the surface casing 18 may be severed below the level of the water bottom 14. In the present example, gas 12 may leak through small channels or other defects in the cement 10 so as to enter the conductor pipe 16 above the severed top of the surface casing 18.

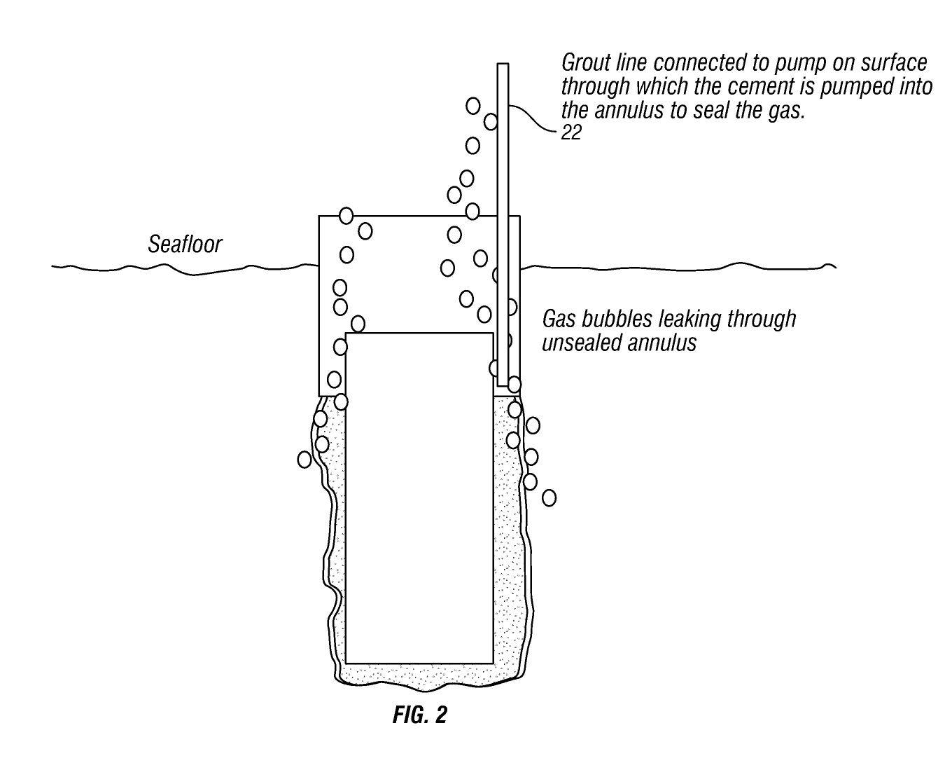

FIG. 2 shows a grout line or “tremie tube” 22 that may extend to a service unit (not shown in the figures) disposed at the surface (e.g., the water surface) which may include devices for pumping cement according to example compositions described herein to a position above the top of the severed surface casing.

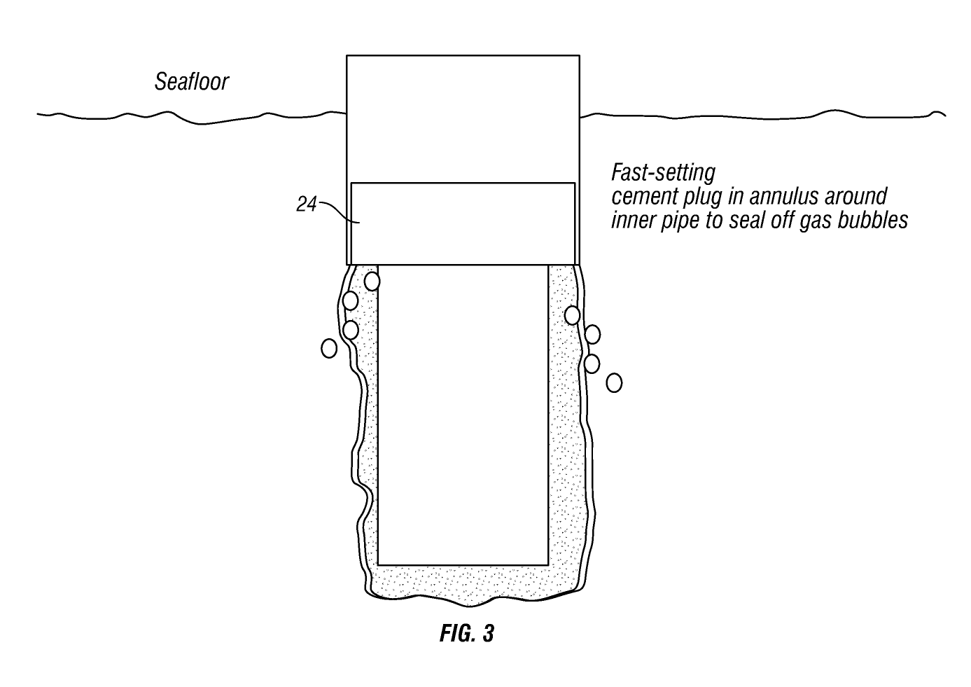

FIG. 3 shows a plug 24 of cement according to various example compositions to be described below sealing above the severed surface casing and thus preventing further leakage of fluid, e.g., gas, into the space above the surface casing.

The cement may be placed by the above described tremie tube (grout line) method as shown in FIG. 2 for a slurry prepared on the surface. In other implementations a tremie tube method may be used wherein the two components are prepared as separate slurries or solutions on the surface and pumped simultaneously in proper proportions to create a solid cement in place, or a tremie tube method may be used wherein one component of an example cement mixture is placed in the wellbore or annulus and another component is pumped afterward so as to start the cement setting as the second component contacts the first component previously placed in the wellbore or annulus. In still other examples, individual materials may be dumped down the wellbore or annulus and allowed to mix in-situ. The tremie tube method (of either form) may be preferred. Dumping may require the cementing materials to have specific gravity higher than the density of the fluids in the wellbore or annulus. Dumping also may require the particle size of the alkali and/or transition metal oxide to be large enough to fall rapidly through the fluids in the annulus. The dumping method also may require encapsulation of highly soluble materials to prevent dissolution before reaching the area to be sealed.

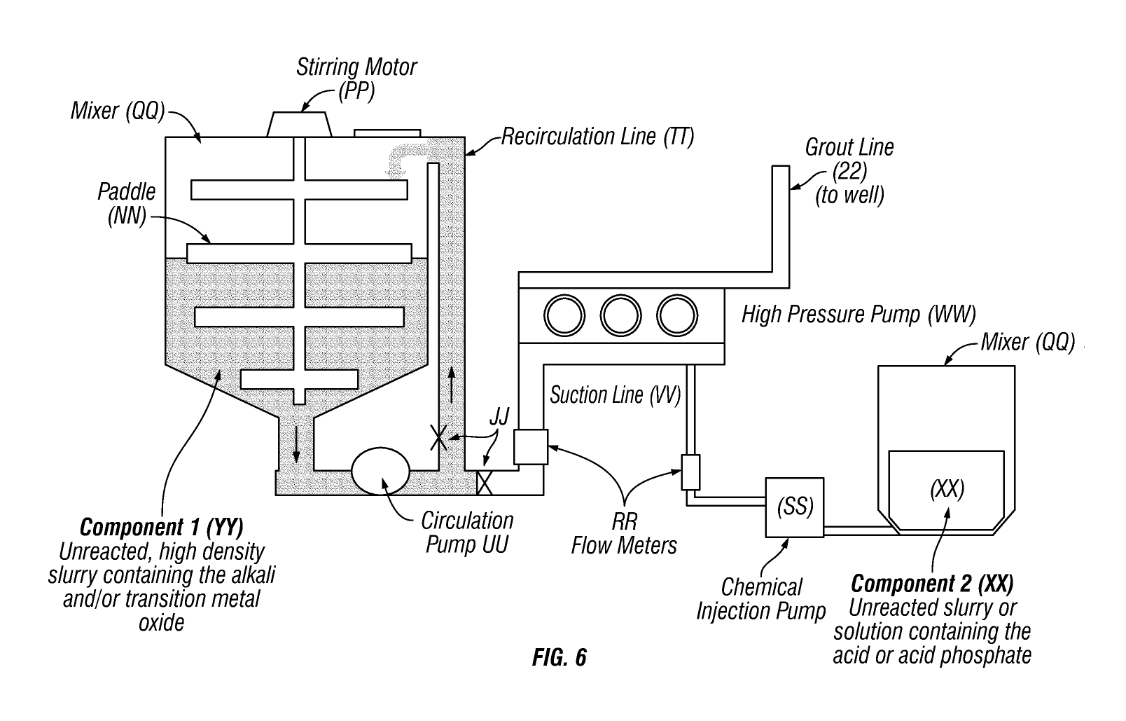

FIG. 6 shows example equipment and an equipment arrangement wherein the two above described example components are mixed together on the surface through the pumping equipment as they are simultaneously pumped into the well. The individual components may be prepared in separate mixers (or containers), shown at QQ. Component 1, shown at YY, is one part of the two component system containing the alkali and/or transition metal oxide (base). Component 2, shown at XX, is one part of the two component system comprising a phosphous-containing acid or acidic salt. Component 1 YY may be transferred from the mixer QQ to a high pressure pump WW through a low pressure suction line VV by a circulation pump UU or similar type pump. Component 2 XX may be simultaneously pumped through a separate line GG into the suction line VV wherein Component 1 YY and Component 2 XX mix as they enter the high pressure pump WW. The mixture may exit the high pressure pump WW through the grout line 22 and may then be conveyed to the well. Flow meters RR may be used to measure flow from mixer QQ to the high pressure pump WW and from a chemical injection pump SS. The flow of Component 2 XX may be regulated by the chemical injection pump SS to maintain the proper ratio of Component 1 YY and Component 2 XX to form a fast-setting cement. It may be beneficial for the preparation of slurries or solutions to use a mixer that has a paddle NN connected to a stirring motor PP to combine all the materials uniformly and keep them suspended in Component 1 YY. It may also be beneficial for the preparation of slurries or solutions to have a the contents of the mixer QQ circulated with the circulation pump UU through a recirculation line TT. Valves JJ may be opened and closed to direct and/or regulate flow through the mixer QQ and/or to the high pressure pump WW.

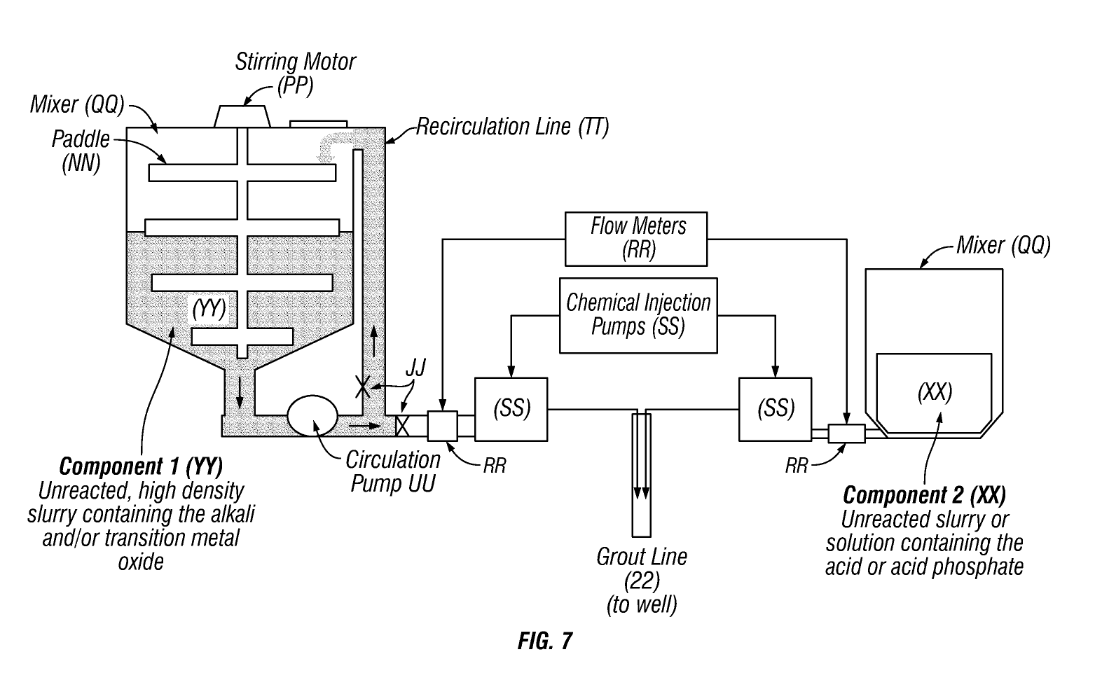

FIG. 7 shows example equipment and an example equipment arrangement wherein the components are pumped through separate lines on or extending below the surface and mixed together closer to or in the well. The individual components may be prepared in separate mixers (or containers) QQ. Component 1 YY is one part of the two component system comprising the alkali and/or transition metal oxide (base). Component 2 XX is one part of the two component system containing a phosphous-containing acid or acidic salt. Component 1 YY is pumped from the mixer QQ by a chemical injection pump SS and pumped through a separate line to the grout line 22. Component 2 XX may be simultaneously pumped through a chemical injection pump SS through a separate line GG into the grout line 22 wherein Component 1 YY and Component 2 XX mix at some point along the grout line 22 as they enter the well. Flow meters RR may be used to measure flow from each chemical injection pump SS to the grout line 22. The flow rates of Component 1 YY and Component 2 XX may be regulated by control of the corresponding chemical injection pump SS to maintain the proper ratio of Component 1 YY and Component 2 XX to form a fast-setting cement. It may be beneficial include a static mixer FF in the grout line 22 to facilitate uniform mixing of Component 1 YY and Component 2 XX. It may be beneficial for the preparation of slurries or solutions to use a mixer QQ that has a paddle NN connected to a stirring motor PP to combine all the materials uniformly and keep them suspended in Component 1 YY. It may also be beneficial for the preparation of slurries or solutions to have a the contents of the mixer QQ circulated with a circulation pump UU through a recirculation line TT. Valves JJ may be opened and closed to direct or regulate flow through mixer QQ and/or to the chemical injection pump SS.

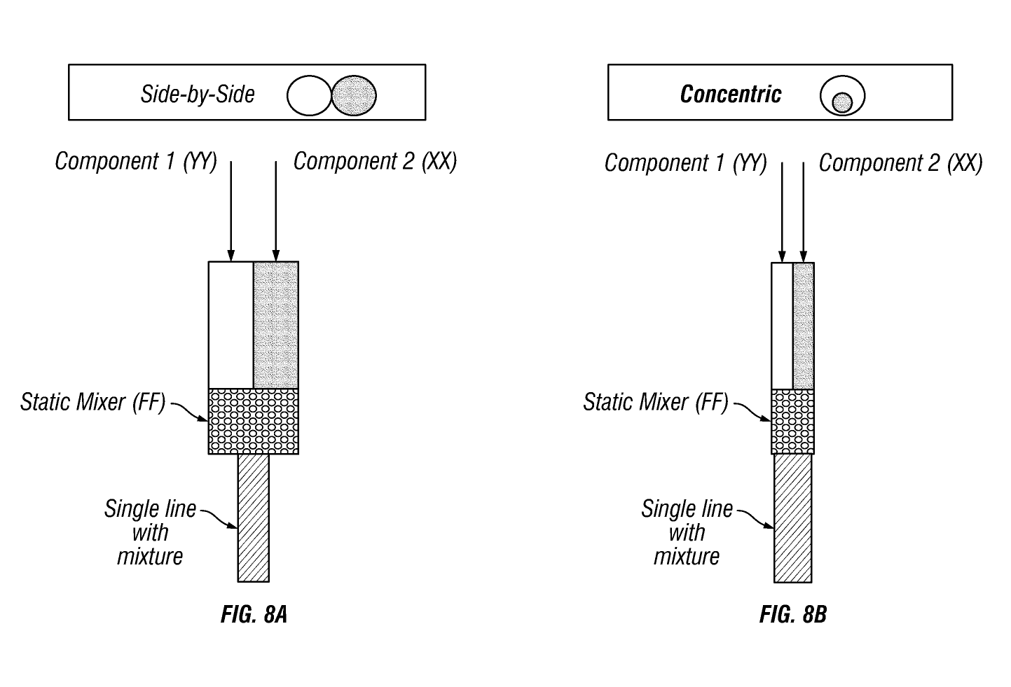

FIGS. 8A and 8B show example configurations of separate material lines for Component 1 YY and Component 2 XX as they combine along the grout line 22. The use and example location of a static in-line Mixer FF is also shown. Combination and mixing of the two components YY and XX may occur along any point in the grout line 22 as long as they are sufficiently uniformly mixed as they are placed in the well.

Encapsulation of one or both of the reactive components of the fast-setting cement may be used to control reaction rate and/or eliminate the need for a chemical retarder for the reaction. Liquid solutions of the acid or acidic phosphorous-containing component may be emulsified in a non-aqueous phase such as hydrocarbons including natural and synthetic oils and esters or water-insoluble glycols. Solid components such as the alkali and/or transition metal oxides or solid acidic and acidicphosphorous containing compounds may be coated with water-soluble polymers or waxy surfactants to inhibit contact with the other component or formation of a reactive solution with or in water that will cause formation of the fast-setting cement.

Prior to pumping the sealing cement, it is desirable to determining the severity of the flow from the leak(s) and to determine the type of fluid flowing from the leak(s), i.e., gas or liquid such as water, brine or oil. It is also advisable to determine the maximum length needed for the sealing cement plug. It is also desirable to determine the setting time of the cement and the required time for placement. It is also desirable to determine the density of the cement plug that will temporarily slow or stop the flow of fluid from the leaking area until the cement sets. The density of the cement plug may range from 11 to 25 pounds per gallon (ppg).

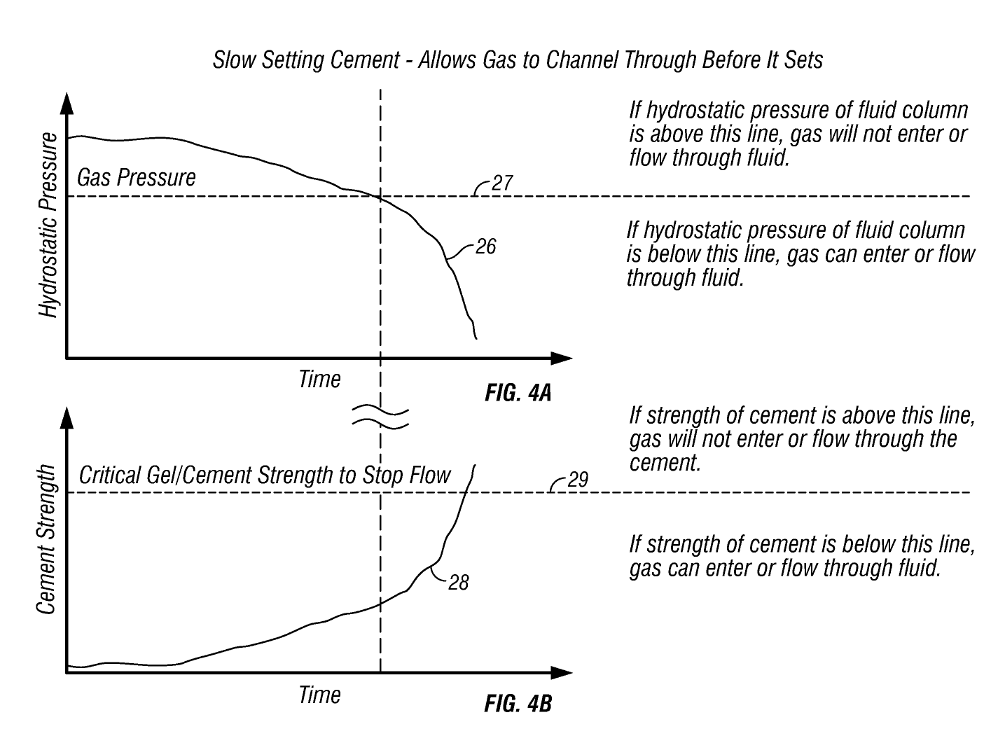

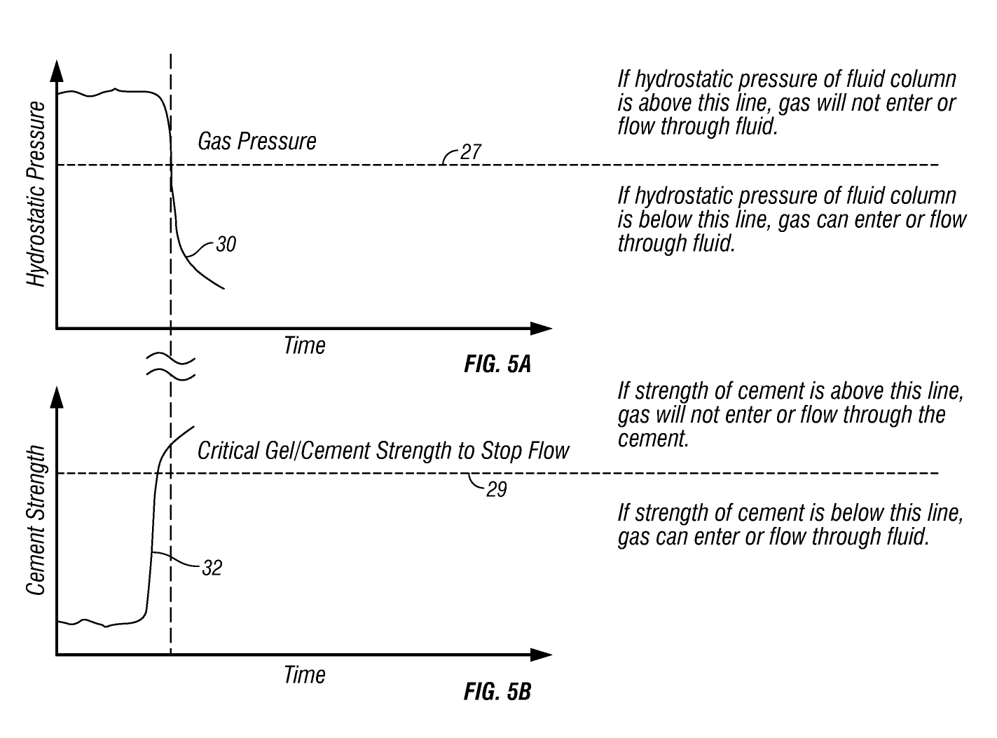

Having explained a placement method for sealing cement to form a plug such as shown in FIG. 3, examples of compositions for the sealing cement will now be explained with reference to FIGS. 4 and 5. A fast setting acid-base cement composed of a first component, which may be an alkali and/or transition metal oxide, and a second component which may be an acid selected from the group of polycarboxylic acid (polyacrylic acid), phosphonic acids, phosphoric acid, polyphosphoric acid, vinyl phosphoric acid, polyvinylphosphoric acid or an acidic phosphate such as ammonium polyphosphate, monoammonium phosphate, mono- or di-hydrogen acidic salts of phosphorous-containing acids, such as lithium, sodium and potassium hydrogen phosphate, lithium, sodium and potassium di-hydrogen phosphate may be used for the cement according to the present disclosure.

The metal oxide may be, for example, magnesium oxide, calcium oxide, aluminum oxide, zinc oxide, zirconium oxide or a magnesium aluminate spinel. A magnesia rich (MgO rich) spinel may be used in some examples. The magnesium oxide content for magnesia rich spinel should be greater than 20 percent (by weight) and preferably between 25 and 40 percent (by weight). The metal oxide can comprise 10 to 100 percent of the solids of the cement slurry and may be between 20 and 100 percent of the total solids and more preferably may be between 30 and 80 percent of the total solids in the slurry.

The metal oxide is preferably calcined or subjected to higher heat treatment to reduce its surface area and reactivity. Example materials include Magox 98 LR (sold by Premier Chemicals), and Magchem 10 (sold by Martin Marietta). A retarder for the cement may be used. For magnesium phosphate or magnesium polyphosphate base cement compositions, a water-soluble borate releasing or generating compound may be used, e.g., boric acid, borax, etc.

High aluminate first component cement may be used as a metal oxide source and reacted with an acidic phosphate or phosphorous acid.

Optionally, a high aluminate first component cement may be mixed with water and an accelerator added to produce a more rapid set. Accelerators for the aqueous high aluminate cement slurry may include lithium salts such as lithium carbonate, lithium chloride, and/or lithium hydroxide, for example.

Optionally, a slurry of high aluminate cement or Portland cement may be suspended in a non-aqueous carrying fluid (such as an oil or ester) and mixed with an accelerator and a water wetting surfactant. Cement reactions occur in water, therefore the setting reactions will not begin until the non-aqueous slurry is mixed with or contacts water. A water-wetting surfactant enhances the absorption of water into the cement slurry to start the setting reactions. Upon contact with water, the slurry viscosity increases and may prevent flow (or washing away of the slurry) until the cement sets.

Most cement slurries and drilling fluids are non-Newtonian fluids having a gel strength selected to suspend solids and have a selected yield point that must be exceeded to initiate flow. The slurry formulations described herein typically have a selected yield point and gel strength to prevent flow of the leaking fluid until the cement sets. Once flow stops, the gel strength of the slurry forms to keep solids in suspension. The gel strength is an electrostatic attraction force. As the gel strength develops and increases, the slurry begins to act more like a solid than a liquid. Therefore the full weight of the slurry is not transmitted to the surrounding pipe or formation in a well. In a wellbore, therefore, the hydrostatic pressure generated by a column of fluid begins to decrease as gel strength develops.

In a leaking well, the fluid flowing through the leak is driven by the pressure of the formation from which it originates. The hydrostatic pressure in the cement and fluid column above the leak must exceed the formation pressure of the fluid being forced through the leak until the cement develops sufficient structural strength to prevent fluid from flowing through it or washing it away from the opening of the leak. FIG. 4A shows a graph of an example of conventionally setting cement, in which the hydrostatic pressure exerted by the cement, shown by curve 26, may fall below that necessary to restrain further leakage of the fluid entering the annular space before the cement develops sufficient strength to stop the fluid leak. As shown by line 27. Correspondingly, FIG. 4B shows a graph of strength at curve 28 of a conventionally setting cement with respect to the strength needed to stop flow, at line 29.

FIG. 5A shows the hydrostatic pressure at curve 30, and FIG. 5B shows corresponding strength at curve 32 of a fast setting cement made using compositions as explained above. The reference pressure and strength curves are shown at lines 27 and 29, as in FIGS. 4A and 4B. As may be observed in FIGS. 5A and 5B, the present example may provide sufficient strength to stop the leak before the hydrostatic pressure exerted by the cement slurry drops below that necessary to stop the leak.

### EXAMPLE FORMULATIONS

A two component, fast setting cement formulation according to the present disclosure may comprise the following:

Two separate liquid mixtures are prepared. Each mixture may contain one component of the two-component system. The solutions are pumped at a specific volumetric ratio and mixed to form a high density, fast setting cement.

### Example 1

Example Mixture 1 may be composed of the following:

| | | |
|---|---|---|
| Mixture 1 Formulation | Amount | Units |

| | |
|---|---|
| Magnesium Oxide | 25 pounds |
| (MagChem 10-200 Grade) | |
| Magnesium Oxide | 60 pounds |
| (MagChem 10-20 Grade) | |
| Magnesium Oxide | 60 pounds |
| (MagChem 10-PR30 Grade) | |
| Borax | 10 pounds |
| (Retarding Agent) | |
| Barium Sulphate | 500 pounds |
| (Density Increasing Agent) | |
| Xanthan Gum Polymer | 0.5 pounds |
| (Suspending Agent) | |
| Water | 21.6 gallons |
| Density | 19.9 pounds/gallon |
| Final Volume | 42 gallons |

Example Mixture 2 may comprise the following:

| | | |
|---|---|---|
| Mixture 2 Formulation | Amount | Units |

| | |
|---|---|
| 10-34-0 Liquid Ammonium | 9.6 gallons |
| Phosphate Fertilizer | |
| (Acidic Phosphate Solution) | |
| Density | 12 pounds/gallon |

These mixtures may be pumped at a volumetric ratio of 4.38:1 (42 gallons of mixture 1 to 9.6 gallons of mixture 2) to produce 51.6 gallons of fast setting cement having a density of 18.4 pounds per gallon when the two mixtures are combined in this volumetric ratio. The hydrostatic pressure from the column of 18.4 pound per gallon cement is used to stop fluid from migrating through the cement slurry until it sets. The xanthan gum polymer is added to the water prior to addition of the magnesium oxide, borax or barium sulphate to suspend solids during mixing. Different particle sizes of the heat-treated magnesium oxide are used to alter viscosity to make a pumpable slurry for equipment and slurry densities required for each application.

### Example 2

Example Mixture 1 is composed of the following:

| | | |
|---|---|---|
| Mixture 1 Formulation | Amount | Units |

| | |
|---|---|
| Magnesium Oxide | 125 pounds |
| (MagChem 10-200 Grade) | |
| Magnesium Oxide | 250 pounds |
| (MagChem 10-20 Grade) | |
| Magnesium Oxide | 225 pounds |
| (MagChem 10-PR30 Grade) | |
| Borax | 10 pounds |
| (Retarding Agent) | |
| Barium Sulphate | 0 pounds |
| (Density Increasing Agent) | |
| Xanthan Gum Polymer | 0.5 pounds |
| (Suspending Agent) | |
| Water | 21.8 gallons |
| Density | 18.6 pounds/gallon |
| Final Volume | 42 gallons |

Example Mixture 2 is composed of the following:

| | | |
|---|---|---|
| Mixture 2 Formulation | Amount | Units |

| | |
|---|---|
| 10-34-0 Liquid Ammonium | 26.4 gallons |
| Phosphate Fertilizer | |
| (Acidic Phosphate Solution) | |
| Density | 12 pounds/gallon |

These mixtures may pumped at a volumetric ratio of 1.59:1 (42 gallons of Mixture 1 to 26.4 gallons of Mixture 2) to produce 68.4 gallons of fast setting cement having a density of 16 pounds per gallon when the two mixtures are combined in this volumetric ratio. The hydrostatic pressure from the column of 16 pound per gallon cement is used to stop fluid from migrating through the cement slurry until it sets. The xanthan gum polymer is added to the water prior to addition of the magnesium oxide, borax or barium sulphate to suspend solids during mixing. Different particle sizes of the heat-treated magnesium oxide are used to alter viscosity to make a pumpable slurry for equipment and slurry densities required for each application.

### Example 3

A plugging operation was designed based upon dumping both components (components as described herein above) down into a leaking well from surface for an onshore well. A solution of Noverite K-7058 polyacrylic acid was poured down into the well from the surface. Dry, coarse, granulated MagChem 10-12×40 mesh magnesium oxide was selected to be poured on top of and to fall through the acidic component to react and form a ductile, fast-setting cement in place. The volume of polyacrylic acid and magnesium oxide can be calculate to provide any required cement column length in the well based upon diameters of the wellbore or casings. A solution of ammonium polyphosphate or other phosphorous containing acids and their acidic salts could be used instead of polyacrylic acid.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A cement composition for sealing leaks in a wellbore, comprising:
at least one of an alkali and a transition metal oxide; and
an acid.

2. The cement composition of claim 1 wherein the alkali or transition metal oxide comprises at least one of magnesium oxide, calcium oxide, aluminum oxide, zinc oxide, zirconium oxide, magnesium aluminate spinel and magnesium oxide spinel.

3. The cement composition of claim 1 wherein the acid comprises at least one of polycarboxylic acid, phosphonic acids, phosphoric acid, polyphosphoric acid, vinyl phosphoric acid, polyvinylphosphoric acid and an acidic phosphate.

4. The cement composition of claim 3 wherein the acidic phosphate comprises at least one of ammonium polyphosphate, monoammonium phosphate and sodium or potassium hydrogen phosphate.

5. The cement composition of claim 1 wherein the at least one of an alkali and a transition metal comprises 10 to 100 percent of a total solids content of the cement composition.

6. The cement composition of claim 5 wherein the at least one of an alkali and a transition metal comprises 20 to 100 percent of a total solids content of the cement composition.

7. The cement composition of claim 6 wherein the at least one of an alkali and a transition metal comprises 30 to 80 percent of a total solids content of the cement composition.

8. The cement composition of claim 1 wherein the at least one of an alkali and a transition metal is calcined or heat treated.

9. The cement composition of claim 1 wherein a density of the cement composition prior to initiating a setting reaction exceeds a hydrostatic pressure of a formation causing the leaks.

10. A method for sealing a leak in cement in a wellbore, comprising:
pumping at least one of an alkali and a transition metal oxide above a leaking part of the wellbore; and
separately pumping an acid above the leaking part of the wellbore to initiate a setting reaction.

11. The method of claim 10 wherein the alkali or transition metal oxide comprises at least one of magnesium oxide, calcium oxide, aluminum oxide, zinc oxide, zirconium oxide, magnesium aluminate spinel and magnesium oxide spinel.

12. The method of claim 1 wherein the acid comprises at least one of polycarboxylic acid, phosphonic acids, phosphoric acid, polyphosphoric acid, vinyl phosphoric acid, polyvinylphosphoric acid and an acidic phosphate.

13. The method of claim 12 wherein the acidic phosphate comprises at least one of ammonium polyphosphate, monoammonium phosphate and potassium hydrogen phosphate.

14. The method of claim 10 wherein the at least one of an alkali and a transition metal comprises 10 to 100 percent of a total solids content of the cement composition.

15. The method of claim 15 wherein the at least one of an alkali and a transition metal comprises 20 to 100 percent of a total solids content of the cement composition.

16. The method of claim 15 wherein the at least one of an alkali and a transition metal comprises 30 to 80 percent of a total solids content of the cement composition.

17. The method of claim 10 wherein the at least one of an alkali and a transition metal is calcined or heat treated.

18. The method of claim 10 wherein a density of the cement composition prior to initiating a setting reaction exceeds a hydrostatic pressure of a formation causing the leaks.
